(19) United States
(12) Patent Application Publication
(10) Pub. No.: US 2009/0249445 A1
(43) Pub. Date: Oct. 1, 2009

(54) Authentication of Websites Based on Signature Matching

(76) Inventors: Sanjay Deshpande, Pune (IN); Nanjundeshwar Ganapathy, Pune (IN); Vikhyat Karumanchi, Pune (IN); Subhadeep Ghosh, Pune (IN)

Correspondence Address: SoCAL IP LAW GROUP LLP, 310 N. WESTLAKE BLVD. STE 120, WESTLAKE VILLAGE, CA, 91362, US

(21) Appl. No.: 12/056,779

(22) Filed: Mar. 27, 2008

(51) Int. Cl. G06F 21/00; G06F 17/30

(52) U.S. Cl. 726/3; 707/3; 707/E17.014

(57) ABSTRACT

There are disclosed methods, computer-readable media, and apparatus for authenticating a target website. A repository that stores data on a plurality of known authentic websites may be provided. The stored data for each of the plurality of known websites may include identifying labels and a signature content set. A target website may be authenticated by comparing the identifying labels and a signature content set of the target website to corresponding data stored in the repository.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to identification and authentication of websites to ensure that a user is connecting to the website he/she intends to connect to.

2. Description of the Related Art

Currently, the menace of “phishing” attacks is spreading across the Internet, and causing irreparable damage to the trust the public has in Internet transactions. In a phishing attack, the attacker attempts to entice a user to believe in a fraudulent website which looks essentially identical to the original website. The objective of such attacks is to gain access to valuable user information including identification information, account numbers, passwords, and other information that would allow the attacker to misappropriate the user's resources, assets, or identity.

Currently, when a user connects to the website, he or she provides the domain name of the website. The browser in turn resolves the domain name using the DNS (Domain Name Server) to an IP address and then connects to the IP address to access the website contents.

A user currently cannot authenticate a website before the website contents are rendered, or displayed on the user's computing device. The look and feel of the information displayed is the only means for the user to believe in the authenticity of the website. However, the information available on the website can be easily copied and a similar looking website can be trivially built. The user is generally unable to check the IP address for a given domain or and may not even check the exact text of the domain name.

Further, even if the website is a secure website that may be accessed using the HTTPS (secure hypertext transfer protocol) or the SSL (secure socket layer) protocol, the protocol only confirms that a given certificate is valid, that the contents have not been tampered, and that the domain name in the certificate indeed is the same as the domain name the user is currently connected to. The protocol can only verify that the certificate belongs to the entity that presented the certificate. In other words, the secure protocols may verify that a website is what it says it is, but that may not verify that the website is what the user thinks it is. Someone attempting a phishing attack can buy a certificate with a domain name that looks similar to the domain name of a target website, and then present the certificate to the user. In this case, the SSL/HTTPS protocols may not be able to tell the user if the user is indeed connected to the website that the user wants to connect to. This is termed the identity binding problem, which is not addressed and cannot be addressed in the way present digital certificate technologies are implemented, since the user is not equipped a priori with the complete information of the certificate with which to authenticate the website.

Hence, the current technologies may not be able to authenticate a website before it is rendered to the end user. Thus the user is left vulnerable to phishing attacks that attempt to entice the user to believe in fraudulent websites that seemingly look identical to the original website. The user may be introduced to the fraudulent website via various channels. The most popular method for initiating a phishing attack is by email.

### DESCRIPTION OF THE DRAWINGS

FIG. 1 is a flow chart of a method for website authentication based on signature matching.

FIG. 2 is a flow chart of a method for website authentication based on signature matching.

FIG. 3 is a flow chart of a method for website authentication based on signature matching.

FIG. 4 is a flow chart of a method for website authentication based on signature matching.

FIG. 5 is a block diagram of an environment for website authentication based on signature matching.

FIG. 6 is a block diagram of a computing device.

Throughout this description, elements appearing in block diagrams are assigned three-digit reference designators, where the most significant digit is the figure number and the two least significant digits are specific to the element. An element that is not described in conjunction with a block diagram may be presumed to have the same characteristics and function as a previously-described element having a reference designator with the same least significant digits.

### DETAILED DESCRIPTION

Description of Processes

A website may be characterized by a set of identifying labels and a signature content set. The identifying labels may include, but are not limited to, a domain name, an IP address, and a digital certificate. The signature content set may contain the content elements that constitute the “signature” of the website, including content such as text, logos, graphics, and other features. The signature content set may include all of the content of a website, or a subset of the content deemed sufficient to verify the authenticity of the website.

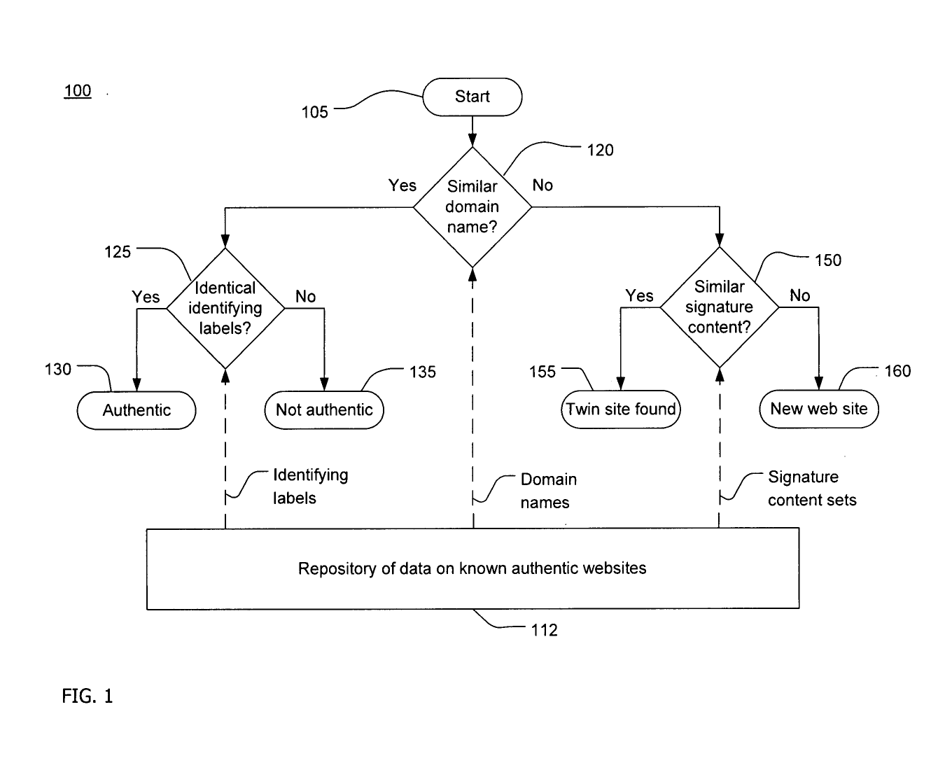

Referring now to FIG. 1, a method 100 for authenticating websites based on signature matching is shown as having a start at 105 and four possible end points 130/135/155/160 depending on the result of the authentication method. However, the method 100 is cyclic in nature and may be repeated every time that a user attempts to open a target website. The user may attempt to open the target website by entering a domain name into a browser application running on the user's computing device. The user may also attempt to open the target website by activating a link presented on another website, in a document, or in an e-mail message. When the user activates a link to access a website, the user may be unaware of the actual domain name of the target website.

The method 100 includes comparing the identifying labels and signature content set of the target website with the identifying labels and signature content sets of known authentic websites, which may be stored in a repository 112. The repository 112 is a secure database in which data on known authentic websites is stored prior to the user attempting to open the target website. Thus the process 100 has a priori knowledge of the IP address, digital certificate, and other identifying labels of known websites.

At 120, a determination may be made whether the domain name of the target website is sufficiently similar to the domain name of a known authentic website stored in the repository 112. Within this description, the term “sufficiently similar” is defined to mean that the difference between two objects, as measured by a predetermined function, is less than a predetermined threshold. In this case, the two objects are the character strings representing the domain names of the target website and each known website. Functions for measuring the difference between two characters strings, which will be discussed in further detail, are well known and commonly used in search engines, automatic spelling checkers, and other applications.

If a determination is made at 120 that the domain name of the target website is sufficiently similar to the domain name of a known authentic website, the method may proceed to 125. At 125, the identifying labels of the target website may be compared to the identifying labels of the known website having the sufficiently similar domain name. These identifying labels may include the IP addresses of the target and known websites, and may include the digital certificates of the target and known websites. If the identifying labels, other than the domain name, of the target website are identical to the corresponding identifying labels of the known website having the sufficiently similar domain name, the target website may be determined to be authentic at 130. If the identifying labels, other than the domain name, of the target website are not identical to the corresponding identifying labels of the known website having the sufficiently similar domain name, the target website may be determined to be not authentic at 135.

If a determination is made at 120 that the domain name of the target website is not sufficiently similar to the domain name of any known authentic website, the method may proceed to 150. At 150, the signature content set of the target website may be compared to the signature content set of each known website. If the signature content set of the target website is determined to be sufficiently similar to the signature content set of at least one known website, the target website may be identified to be a twin site at 160. The identification of a twin site may be evidence of a phishing attack. If the signature content set of the target website is determined to be not sufficiently similar to the signature content set of any known website, the target website may be identified to be a newly discovered web site at 160.

The method 100 for authenticating a website may be described mathematically. A website w may be defined by w=(L, C), where L are the various identifying labels and C is the signature content set of the website. The set of labels L may be further defined as L=(D, IP, CERT), where D is the domain name, IP is the IP address, and CERT is the digital certificate.

Given an a priori set W of known websites w, the identity of a target website w′=(L′, C′) may be confirmed by the following algorithm:
a. Find in W a known website w such that F1(w′(L′(D′)), w(L(D)))≦ε1, where F1 is a function that measures the difference between w′(L′(D′)) and w(L(D)) and ε1 is a suitable constant. The equation F1(w′(L′(D′)), w(L(D)))≦ε1 is an example of a mathematical definition of whether a known website and a target website have domain names that are “sufficiently similar”. The function F1 may be a “distance” function that measures the difference between the known and target domain names. The function F1 may have a value of zero when the known and target domain names are identical, and a larger value if the known and target domain names are different. The function F1 may be normalized to a range from 0 to 1, with a value of 1 indicating that there is no similarity between the known and target domain names. Where the function F1 is normalized, the constant ε1 may be a small value such as 0.1 or less.
b. If a website w can be found in W, target website w′ is authentic if w′(L′(IP′))=w(L(IP)) and, where a digital certificate is presented, w′(L′(CERT′))=w(L(CERT)). Thus the target website w′ is considered authentic if it has a “sufficiently similar” domain name and exactly the same IP address and digital certificate (where presented) as a known website w contained within the set W.
c. If a known website w can be found in W, the target website w′ is Not Authentic if w′(L′(IP′))≠w(L(IP)) or, where a digital certificate is presented, if w′(L′(CERT′))≠w(L(CERT)). Thus the target website w′ is considered Not Authentic if it has a sufficiently similar domain name to a known website w, but either the IP address or digital certificate (where presented) do not match those of the known website w.
d. If a known website w cannot be found in W, then search W for a known website w″ such that F2(w′(C′), w″(C″)≦ε2, where F2 is a function that measures the difference between w′(C′) and w″(C″) and ε2 is a suitable constant. This step may be described as finding a known website w″ having signature content set that is “sufficiently similar” to the signature content set of the target website w′ according to a predetermined measure. If such a website w″ can be found in W, then the target website w′ may be identified as a twin site of known website w″ and may be evidence of a phishing attack.
e. If neither a known website w nor a known website w″ can be found in W, then the target website w′ is determined to be a newly discovered website that may be considered for inclusion in the set of websites W.

A number of functions for measuring the difference or distance between two objects, such as two domain names or two signature content sets, are known and commonly used in search engines, spell checking programs, and other applications. For example, the Levenshtein Distance Function measures the difference or distance between two character strings by counting the number of edit operations (character insertion, deletion, or substitution) required to convert the first character string into the second character string. The Levenshtein Distance Function may be normalized by dividing the number of edit operations by the total length of the two character strings. In this case, the normalized Levenshtein Distance Function may have a value between 0 and 1, where a value of 0 indicates that the two strings are identical, and a value of 1 indicates that the two strings have no characters in common.

Other functions that may be employed to measure the distance between the domain names w′(L′(D′)) and w(L(D)) include the Smith-Waterman distance function, the Damerau-Levenshtein distance function, the Jaro-Winkler distance function, the Jaccard distance function, and other dissimilarity measures. Where necessary, any of these distance functions may be normalized such that the numerical result is independent of the number of characters in the domain names D and D′.

Alternatively, the domain names w′(L′(D′)) and w(L(D)) may be compared using a function that measures the similarity between the domain names. In this case, step a. may be rewritten as follows:
a. Find in W a known website w such that F′1(w′(L′(D′)), w(L(D)))≧ε1, where F′1 is a function that measures the similarity between w′ (L′(D′)) and w(L(D)) and ε1 is a suitable constant. The equation F′1(w′(L′(D′)), w(L(D)))≧ε1 is a second example of a mathematical definition of whether a known website and a target website have domain names that are “sufficiently similar”. The function F′1 may be normalized to a range from 0 to 1, with a value of 0 indicating that there is no similarity between the known and target domain names and a value of 1 indicating that the domain names are identical. Where the function F′1 is normalized, the constant ε1 may be a value such as 0.9 or more.

For example, the Levenshtein distance function can be converted into a similarity function: similarity=[(string length of target−Levenshtein distance between the target and the reference)/string length of target].

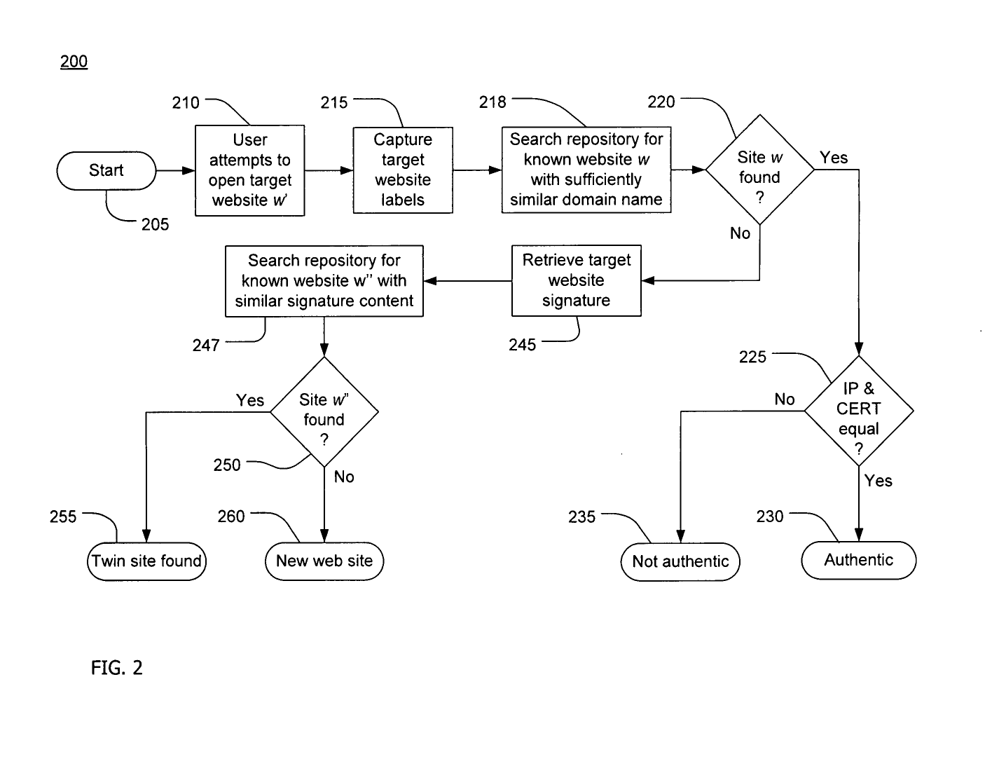

Referring now to FIG. 2, a method 200 for authenticating websites based on signature matching is shown as having a start at 205 and four possible end points 230/235/255/260 depending on the result of the authentication method. However, the method 200 is cyclic in nature and may be repeated every time that a user attempts to open a target website at 210.

At 215, the identifying labels for the target website may be captured. These labels may include at least a domain name and an IP address (IP′), and may include a digital certificate (CERT′) and other label information. Capturing the identifying labels may include receiving a domain name from the user's web browser, providing the domain name to a Domain Name Server over a network and receiving an IP address, and then placing an inquiry to the IP address and receiving a digital certificate. At 218, a repository or memory storing a set of data of known websites may be searched to attempt to locate a domain name that is sufficiently similar to the domain name of the target website.

At 220, a determination is made if the repository contains a domain name that is sufficiently similar to the domain name of the target website. If a sufficiently similar domain name has been found, the known website associated with the sufficiently similar domain name may be identified. At 225, the other identifying labels of the known website associated with the sufficiently similar domain name may be compared to the corresponding identifying labels of the target website. If the identifying labels, other than the domain names, of the known website and the target website are identical, the method 200 ends at 230 with the result that the target website is determined to be authentic. If any of the identifying labels of the known website and the target website are not identical, the method 200 ends at 235 with the target website determined to be not authentic. In either event, information indicating that the target website was, or was not, authentic may be provided to the user and/or the browser program running on the user's computing device.

In the case where the method 200 results in a determination that the target website is authentic, the target website may simply be rendered on the display of the user's computing device. In the case where the method 200 results in a determination that the target website is not authentic, a message may be displayed indicating that the authentication method was not successful. In this later case, the target website may not be rendered automatically, but the user may be given an option (not shown) to open to the target website even though authentication was not successful.

If a determination is made at 220 that the repository did not contain a domain name that is sufficiently similar to the domain name of the target website, the signature content set of the target website may be retrieved at 245. At 247, the repository storing the data on the set of known websites may be searched to attempt to locate a signature content set that is sufficiently similar to the signature content set of the target website.

The function used to measure the difference between the signature content set of the target website and the signature content sets of known websites may be the same as the function used to compare domain names or a different function. The function may be selected from the various distance functions previously described with respect to comparing domain names, or may be another function. The function may be a plurality of different functions used to compare different data types within the signature content of the websites.

For example, the signature content for each website may include both text strings and images, such as logos, extracted from the HTML content of the websites. The images may be compared using a standard auto-correlation function and/or any binary function that returns a true or false based on the RGB values of the image at the corresponding x,y pixel locations within the images. Further, images may be normalized to a predetermined size prior to comparison. Text strings in the content of the target website may be compared to text strings in the signature content set of the known website using a distance function or similarity function as previously described with respect to comparing domain names. The results of the comparisons of the elements of the signature content sets may be combined into a single value indicating the similarity of the signature content set of the target website and the signature content sets of known websites.

At 250, a determination is made if the repository contains a signature content set that is sufficiently similar to the signature content set of the target website. If a sufficiently similar signature content set has been found, the target website may be identified as a twin of the known website at 260. The identification of a twin website may indicate a phishing attack. If a sufficiently similar signature content set has not been found, the target website may be identified as a newly found website at 260.

In the case where the method 200 identifies the target website as a newly found website, the target website may simply be rendered on the display of the user's computing device. The target website may also be considered as a candidate for inclusion in the set W of known websites. Further research, such as contacting the proprietors or webmaster of the newly found website may be undertaken before data on the newly found website is added to W.

In the case where the target website has been identified as a twin of a known website, a message may be displayed indicating that the target website may be part of a phishing attack. In this case, the target website may not be automatically rendered, but the user may be given an option to open to the target website even though it may be associated with a phishing attack.

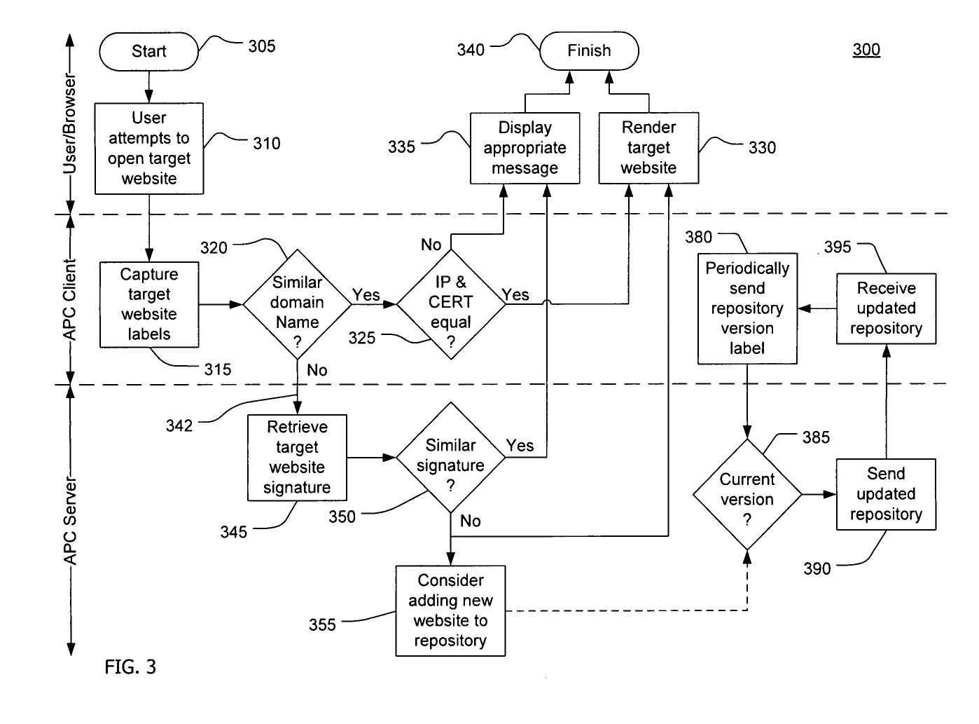

Referring now to FIG. 3, a method 300 for authenticating websites based on signature matching may be performed by an APC (advanced phish check) client and an APC server. The APC client may be embodied in whole or in part in software which operates on the user's computing device and may be in the form of an application program, an applet (e.g., a Java applet), a browser helper object (BHO), a browser plug-in, a COM object, a dynamic linked library (DLL), a script, one or more subroutines, or an operating system component or service. The APC client may include instructions stored on a storage media and/or downloaded via the Internet or other network. The method 300 is shown as having a start at 305 and a finish at 340. However, the method 300 is cyclic in nature and may be repeated every time that a user attempts to open a target website at 310.

At 315, the APC client may capture the identifying labels for the target website. These labels may include a domain name, an IP address, a digital certificate, and other label information. The APC client may interact with a browser program operating on the user's computing device to capture the identifying labels. At 320, a client repository storing a set of known websites may be searched to determine if the client repository contains a domain name that is sufficiently similar to the domain name of the target website. The client repository of known websites may be stored on the user's computing device and may include the identifying labels for each known website.

If a sufficiently similar domain name has been found, the known website associated with the sufficiently similar domain name may be identified. At 325, the other identifying labels of the known website associated with the sufficiently similar domain name may be compared to the corresponding identifying labels of the target website. If the identifying labels, other than the domain names, of the known website and the target website are identical, the APC client may report to the browser program that the target website is determined to be authentic. The APC client may cause the browser program to render the target website onto a display device at 330, and the process 300 may terminate at 340.

If, at 325, any of the IP addresses, the digital certificates, or other identifying labels of the known website and the target website are not identical, the target website is determined to be not authentic. The APC client may cause the browser program to display a message informing the user of the authentication failure at 335. The method 300 may then conclude at 340.

If a determination is made at 320 that the repository did not contain a domain name that is sufficiently similar to the domain name of the target website, the APC client may open a secure communication channel 342 to the APC server. The APC server may receive the identification labels from the APC client and may then retrieve the signature content set of the target website at 345. The signature content set of the target website may also be retrieved by the APC client at 315 and transmitted to the APC server along with the identifying labels.

At 350, a determination may be made if a server repository storing data on a set of known websites contains a signature content set that is sufficiently similar to the signature content set of the target website. The server repository may be stored within the APC server or may be stored within a storage device coupled to the APC server. The server repository may contain the identification labels and the signature content sets of the known websites.

If the server repository contains a signature content set that is sufficiently similar to the signature content set of the target website, the target website may be identified as a twin site at 350 (350=Yes). The identification of a twin website may indicate a phishing attack. The APC server may then send a message to the APC client identifying the target website as a twin site, and the APC client may display, or cause the browser to display, an appropriate message at 335. The method 300 may then terminate at 340.

If the server repository does not contain a signature content set that is sufficiently similar to the signature content set of the target website, the target website may be identified as a newly discovered website at 350 (350=NO). The APC server may then send a message to the APC client identifying the target website as a newly found website, and the APC client may cause the browser to render the website at 330. The method 300 may then terminate at 340.

In the case where the target website has been identified as a newly found website, the target website may be considered at 355 as a candidate for inclusion in the client repository and the server repository of known websites. Further research, such as contacting the proprietors or webmaster of the newly found website may be undertaken before the website is added to the server and/or client repositories.

Newly discovered websites may be added to the server repository whenever the required further research is completed. The APC server may then update the client repository immediately or periodically, such as nightly or weekly. An exemplary method for updating the client repository is shown from 380 to 395. At 380, the APC client may open a secure communication channel to the server and provide the server with information, such as a version label, indicating the present version of the client repository. At 385, the APC server may determine if the client repository is current. If the client repository is current, the APC server may send updated repository information to the client at 390. The client may receive and store the updated repository information at 395. The updated repository information may include the entire current version of the repository, or may include only information for websites that have been added or modified.

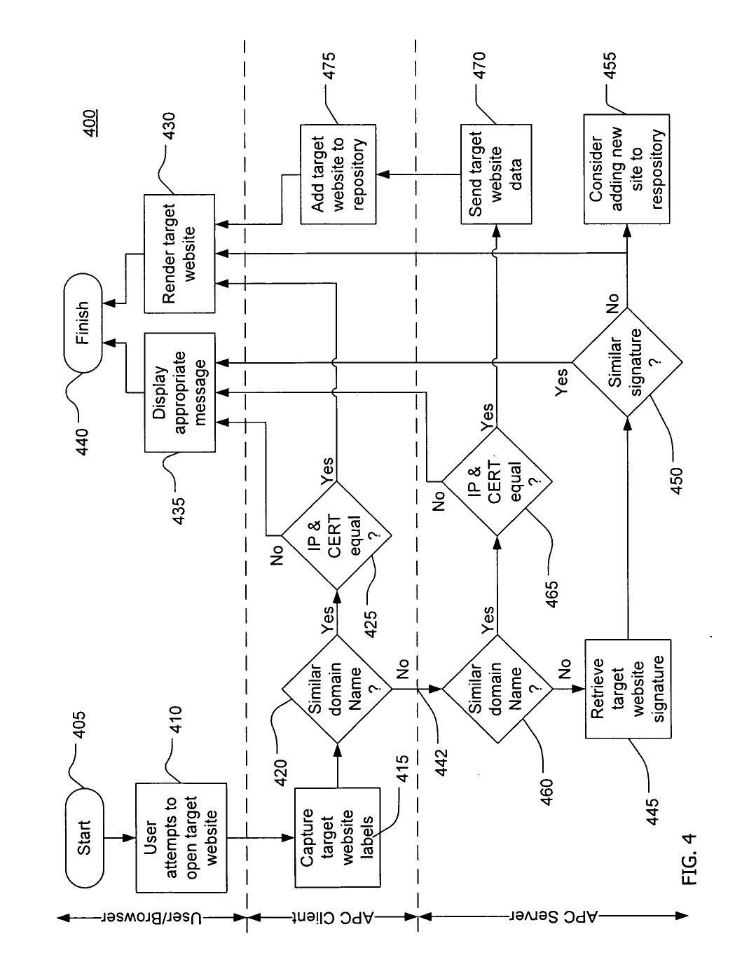

Referring now to FIG. 4, another method 400 for authenticating websites based on signature matching may be performed by an APC (advanced phish check) client operating on a user's computing device and an APC server. The method 400 is shown as having a start at 405 and a finish at 440. However, the method 400 is cyclic in nature and may be repeated every time that a user attempts to open a target website at 410. The method 400 may be essentially the same as the method 300 from 405 to 440, and these elements of the method 400 will not be described again.

If a determination is made at 420 that the client repository of known websites did not contain a domain name D that is sufficiently similar to the domain name of the target website, the APC client may open a secure communication channel 442 to the APC server. The APC client may then send the identification labels of the target website to the APC server.

At 460, a server repository storing data on a set of known websites may be searched to determine if the server repository contains a domain name that is sufficiently similar to the domain name of the target website. The server repository of data on known websites may be stored within the APC server or within a storage device coupled to the APC server, and may include the identifying labels and signature content sets for each known website.

If a sufficiently similar domain name has been found, the known website associated with the sufficiently similar domain name may be identified. At 465, the other identifying labels of the known website associated with the sufficiently similar domain name may be compared to the corresponding identifying labels of the target website. If the identifying labels, other than the domain names, of the known website and the target website are identical, the APC server may send a message to the APC client indicating that the target website is authentic. The APC server may also send the identifying labels and other data on the target website to the APC client at 470, and the APC client may add the data on the target website to the APC repository at 475. The APC client may cause the browser program to render the target website onto a display device at 430, and the process 400 may terminate to 440.

If, at 465, any of the IP addresses, the digital certificates, or other identifying labels of the known website and the target website are not identical, the target website is determined to be not authentic. The APC server may then send a message to the APC client indicating that the target website is not authentic. The APC client may cause the browser program to display a message at 435 informing the user of the authentication failure. The method 400 may then conclude at 440.

If, at 460, a determination is made that the server repository does not include a domain name sufficiently similar to the domain name of the target website, the signature content set of the target website may be retrieved at 445. The signature content set of the target website may also be retrieved by the APC client at 415 and transmitted to the APC server along with the identifying labels.

At 450, a determination may be made if the server repository contains a signature content set that is sufficiently similar to the signature content set of the target website.

If the server repository contains a signature content set that is sufficiently similar to the signature content set of the target website, the target website may be identified as a twin site at 450 (450=Yes). The identification of a twin website may indicate a phishing attack. The APC server may then send a message to the APC client identifying the target website as a twin site, and the APC client may then display, or cause the browser to display, an appropriate message at 435. The method 400 may then terminate at 440.

If the server repository does not contain a signature content set that is sufficiently similar to the signature content set of the target website, the target website may be identified as a newly discovered website at 450 (450=NO). The APC server may then send a message to the APC client identifying the target website as a newly found website, and the APC client may cause the browser to render the website at 430. The method 400 may then terminate at 440.

In the case where the target website has been identified as a newly found website, the target website may be considered at 455 as a candidate for inclusion in the client repository and the server repository of known websites. Further research, such as contacting the proprietors or webmaster of the newly found website, may be undertaken before the website is added to the server and/or client repositories.

With regard to the methods 100, 200, 300, and 400 additional and fewer steps may be taken, and the steps as shown may be combined, reordered, or further refined to achieve the methods described herein. For example, the target website signature content set may be retrieved at the same time the target website identifying labels are obtained. Additionally, the elements 460 and 465 of method 400 may be performed for every target website, and the target website may be rendered on the user's computing device only if both the APC client and the APC server successfully authenticate the target website.

Description of Apparatus

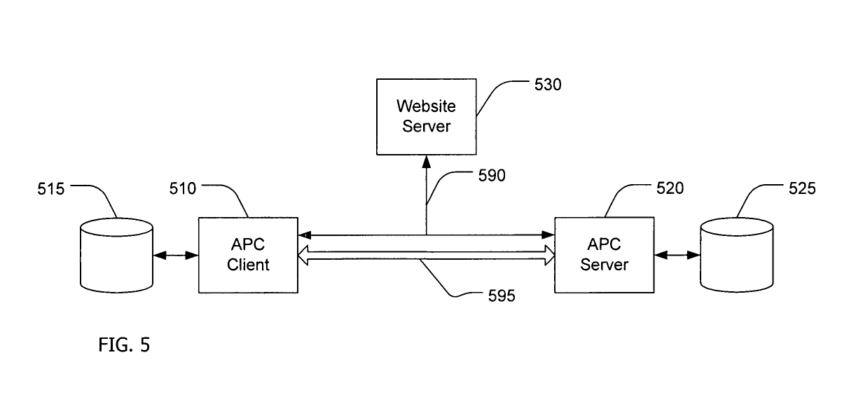

Referring now to FIG. 5, an environment for website authentication based on signature matching may include an APC client 510, an APC server 520, and a website server 530. Each of the APC client 510, the APC server 520, and the website server 530 may be implemented by a computing device running an associated software program.

The APC client 510 may be coupled to a client storage unit 515. The client storage unit 515 may store programs in the form of instructions to be executed by the APC client computing device. The client storage unit 515 may also store data required in the operation of the APC client, including a client repository of data on known websites. The client repository of known website may include at least the identifying labels of the known websites.

The APC server 520 may be coupled to a server storage unit 525. The server storage unit 525 may store programs in the form of instructions to be executed by the APC server computing device. The server storage unit 525 may also store data required in the operation of the APC server, including a server repository of data on known websites. The client repository of data on known websites may include at least the signature content sets of the known websites and may also store the identifying labels of the known websites.

Each of the client storage unit 515 and the server storage unit 525 may include one or more storage devices. As used herein, a storage device is a device that allows for reading and/or writing to a storage medium. Storage devices include hard disk drives, DVD drives, flash memory devices, and others. Each storage device may contain a fixed or removable computer-readable storage media. These computer-readable storage media include, for example, magnetic media such as hard disks, floppy disks and tape; optical media such as compact disks (CD-ROM and CD-RW) and digital versatile disks (DVD and DVD±RW); flash memory cards; and other storage media.

The APC client 510 and the APC server 520 may be implemented with any capable computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Unix, MS-DOS, Microsoft Windows, Palm OS, Solaris, Symbian, and Apple Mac OS X operating systems.

The processes, functionality and features of the APC client and the APC server may be embodied in whole or in part in software which operates on a computing device and may be in the form of firmware, an application program, an applet (e.g., a Java applet), a browser plug-in, a COM object, a dynamic linked library (DLL), a script, one or more subroutines, or an operating system component or service. The hardware and software and their functions may be distributed such that some components are performed by a computing device and others by other devices. The software may be stored on a computer readable storage media in the form of instructions, which when executed by a computing device, cause the APC client and/or APC server to perform the functions described herein.

The APC client 510, the APC server 520, and the website server 530 may be linked by a communication network 590, which may be the Internet. The APC client 510 and the APC server 520 may also be linked by a secure authenticated communication channel 595. The secure authenticated communication channel 595 may be implemented using a secure communication protocol over the network 590, or may be a WAN, LAN, or other private network.

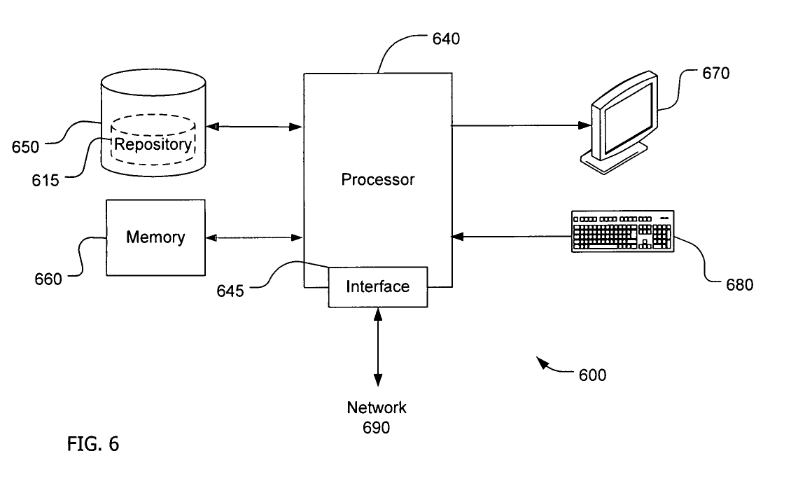

Referring now to FIG. 6, a computing device 600, which may be suitable for the client 510 or the server 520 of FIG. 5, may include a processor 640 coupled to memory 660 and a storage device 650. The processor 610 may include circuits, devices, and software required for the computing device 600 to provide at least a portion of the functions described herein. The storage device 650 may store instructions and data required for the computing device 600 to provide at least a portion of the functions described herein. The storage device 650 may also store a repository 615 of data on known websites.

The processor may include or be coupled to an interface 645 for a network 690. The processor may also be coupled to an input device, such as keyboard 680, and an output device such as display device 670. The processor may be coupled to other input and output devices including a mouse or other pointing device (not shown) and a printer (not shown).

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method for authenticating a target website, comprising:
providing a repository that stores data on a plurality of known authentic websites, the data for each of the plurality of known websites including identifying labels and a signature content set
comparing identifying labels and a signature content set of the target website to corresponding data stored in the repository.

2. The method for authenticating a target website of claim 1, wherein the comparing further comprises determining if the domain name of one of the plurality of known websites is sufficiently similar to the domain name of the target website.

3. The method for authenticating a target website of claim 2, wherein a domain name of a known website is determined to be sufficiently similar to the domain name of the target website if the following equation is satisfied:
F1(w′(L′(D′)), w(L(D)))≦ε1,
where: w′(L′(D′)) is the domain name of the target website,
w(L(D)) is the domain name of a known website,
F1 is a function that measures the difference between w′(L′(D′)) and w(L(D)), and ε1 is a suitable constant.

4. The method for authenticating a target website of claim 3, wherein the function F1 is selected from the group consisting of Levenshtein distance function, Smith-Waterman distance function, Damerau-Levenshtein distance function, Jaro-Winkler distance function, and Jaccard distance function.

5. The method for authenticating a target website of claim 2, wherein a domain name of a known website is determined to be sufficiently similar to the domain name of the target website if the following equation is satisfied:
F′1(w′(L′(D′)), w(L(D)))≧ε1,
where: w′(L′(D′)) is the domain name of the target website,
w(L(D)) is the domain name of a known website,
F′1 is a function that measures the similarity between w′(L′(D′)) and w(L(D)), and ε1 is a suitable constant.

6. The method for authenticating a target website of claim 2, wherein the comparing further comprises:
when the domain name of one of the plurality of known websites is determined to be sufficiently similar to the domain name the target website
determining the target website to be authentic if identifying labels of the target website, other than the domain name, are identical to corresponding identifying labels of the known website having the sufficiently similar domain name
determining the target website to be not authentic if the identifying labels, other than the domain name, of the target website are not identical to the corresponding identifying labels of the known website having the sufficiently similar domain name
if none of the plurality of known websites has a domain name sufficiently similar to the domain name of the target website
determining the target website to be a twin site if the signature content set of the target website is sufficiently similar to the signature content set of any of the plurality of known websites
determining the target website to be a newly found site if the signature content set of the target website is not sufficiently similar to the signature content set of any of the plurality of known websites.

7. The method for authenticating a target website of claim 6, wherein a signature content set of a known website is determined to be sufficiently similar to the signature content set of the target website if the following equation is satisfied:
F2(w′(C′), w″(C″))≦ε2,
where: w′(C′) is the signature content set of the target website,
w″(C″) is the signature content set of a known website,
F2 is a function that measures the difference between w′(C′) and w″(C″), and
ε2 is a suitable constant.

8. The method for authenticating a target website of claim 6, wherein a signature content set of a known website is determined to be sufficiently similar to the signature content set of the target website if the following equation is satisfied:
F′2(w′(C′), w″(C″))≧ε2,
where: w′(C′) is the signature content set of the target website,
w″(C″) is the signature content set of a known website,
F′2 is a function that measures the similarity between w′(C′) and w″(C″), and
ε2 is a suitable constant.

9. The method for authenticating a target website of claim 6, further comprising:
if the target website is determined to be authentic or determined to be a newly located website, causing the target website to be rendered on a display device
if the target website is determined to be unauthentic or determined to be a twin site, causing an appropriate message to be displayed without rendering the target website.

10. The method for authenticating a target website of claim 1, wherein the identifying labels of the target website include an IP address.

11. The method for authenticating a target website of claim 10, wherein the identifying labels of the target website further comprises a digital certificate.

12. A method for authenticating a target website, comprising:
providing a repository of data on known websites, the data including a plurality of identifying labels and a signature content set for each known website, wherein the plurality of identifying labels includes a domain name
capturing a plurality of identifying labels for the target website, the plurality of identifying labels including a domain name of the target website
determining if the repository contains a domain name sufficiently similar to the domain name of the target website
if the repository contains a domain name sufficiently similar to the domain name of the target website
determining the target website to be authentic if all of the identifying labels for the target website, other than the domain name, are identical to the corresponding identifying labels of the known website corresponding to the sufficiently similar domain name
determining the target website to be not authentic if any of the identifying labels for the target website, other than the domain name, are not identical to the corresponding identifying labels of the known website corresponding to the sufficiently similar domain name
if the repository does not contain a domain name sufficiently similar to the domain name of the target website
if the repository contains a signature content set similar to the signature content set of the target website, determining the target website to be a twin site
if the repository does not contain a signature content set sufficiently similar to the signature content set of the target website, determining the target website to be a newly located website.

13. A method for authenticating a target website comprising:
when a user attempts to open a target website, a client operating on the user's computing device capturing a plurality of identifying labels for the target website, the plurality of identifying labels including at least a domain name of the target website
the client determining if a client repository of data on known websites contains a domain name sufficiently similar to the domain name of the target website
if the client repository contains a domain name sufficiently similar to the domain name of the target website
the client determining the target website to be authentic if all of the identifying labels for the target website, other than the domain name, are identical to the corresponding identifying labels of the known website corresponding to the sufficiently similar domain name
the client determining the target website to be not authentic if any of the identifying labels for the target website, other than the domain name, are not identical to the corresponding identifying labels of the known website corresponding to the sufficiently similar domain name
if the client repository does not contain a domain name sufficiently similar to the domain name of the target website
a server determining if a server repository of data on known websites contains a signature content set sufficiently similar to the signature content set of the target website
if the server repository contains a signature content set sufficiently similar to the signature content set of the target website, the server determining the target website to be a twin site
if the server repository does not contain a signature content set sufficiently similar to the signature content set of the target website, the server determining the target website to be a newly located website.

14. The method for authenticating a target website of claim 13, further comprising the server periodically sending data to the client to update the client repository.

15. The method for authenticating a target website of claim 13, further comprising:
when the client repository does not contain a domain name sufficiently similar to the domain name of the target website
the server determining if the server repository of data on known websites contains a domain name sufficiently similar to the domain name of the target website
if the server repository contains a domain name sufficiently similar to the domain name of the target website
the server determining the target website to be authentic if all of the identifying labels for the target website, other than the domain name, are identical to the corresponding identifying labels of the known website corresponding to the sufficiently similar domain name
the server determining the target website to be not authentic if any of the identifying labels for the target website, other than the domain name, are not identical to the corresponding identifying labels of the known website corresponding to the sufficiently similar domain name.

16. The method for authenticating a target website of claim 15, further comprising the server sending data on the target website to the client to update the client repository when the server determines that the target website is authentic.

17. A method for authenticating a target website, comprising:
a client capturing a plurality of identifying labels for a target website, the plurality of identifying labels including at least a domain name of the target website
the client determining if stored data on known websites contains a domain name sufficiently similar to the domain name of the target website
if the stored data contains a domain name sufficiently similar to the domain name of the target website
the client determining the target website to be authentic if the plurality of identifying labels for the target website, other than the domain name, are identical to the corresponding identifying labels of the known website corresponding to the sufficiently similar domain name
the client determining the target website to be not authentic if any of the plurality of identifying labels for the target website, other than the domain name, is not identical to the corresponding identifying label of the known website corresponding to the sufficiently similar domain name
if the stored data does not contain a domain name sufficiently similar to the domain name of the target website
the client sending the plurality of identifying labels of the target website to a server
the client receiving a message from the server indicating that the target website is one of authentic, not authentic, a twin site, and a newly found website.

18. The method for authenticating a target website of claim 17, further comprising:
the client causing a web browser to render the target website on a display device if the target web site is determined to be authentic
the client causing the web browser to render the target website on the display device if the message indicates the target website is one of authentic and a newly found web site
the client causing an appropriate message to be displayed if the target website is determined to be not authentic
the client causing an appropriate message to be displayed if the message indicates that the target website is one of not authentic and a twin site.

19. A computer-readable storage medium having a client program stored thereon, the client program comprising instructions which, when executed by a processor, will cause the processor to perform actions including:
capturing a plurality of identifying labels for a target website, the plurality of identifying labels including at least a domain name of the target website
determining if stored data on known websites contains a domain name sufficiently similar to the domain name of the target website
if the stored data contains a domain name sufficiently similar to the domain name of the target website
determining the target website to be authentic if the plurality of identifying labels for the target website, other than the domain name, are identical to the corresponding identifying labels of the known website corresponding to the sufficiently similar domain name
determining the target website to be not authentic if any of the plurality of identifying labels for the target website, other than the domain name, are not identical to the corresponding identifying labels of the known website corresponding to the sufficiently similar domain name
if the stored data does not contain a domain name sufficiently similar to the domain name of the target website
sending the plurality of identifying labels of the target website to a server
receiving a message from the server indicating that the target website is one of authentic, not authentic, a twin site, and a newly found website.

20. The computer-readable storage medium of claim 19, the actions performed further comprising:
causing a web browser to render the target website on a display device if the target web site is determined to be authentic
causing the web browser to render the target website on the display device if the message indicates the target website is one of authentic and a newly found web site
causing an appropriate message to be displayed if the target website is determined to be not authentic
causing an appropriate message to be displayed if the message indicates that the target website is one of not authentic and a twin site.

21. A computing device to authenticate a target website, the computing device comprising:
a processor
a memory coupled with the processor
a storage medium having instructions stored thereon which when executed cause the computing device to perform actions comprising
receiving a plurality of identifying labels of the target website from a client
acquiring the signature content set of the target website using one or more of the plurality of identifying labels
determining if a server repository of data on known websites contains a signature content set sufficiently similar to the signature content set of the target website
if the server repository contains a signature content set sufficiently similar to the signature content set of the target website, determining the target website to be a twin site
if the server repository does not contain a signature content set sufficiently similar to the signature content set of the target website, determining the target website to be a newly located website
sending a message to the client indicating that the target website is one of a twin site and a newly found web site.
